(19) United States
(12) Patent Application Publication
(10) Pub. No.: US 2022/0004650 A1
(43) Pub. Date: Jan. 6, 2022

(54) DATA MANAGEMENT SYSTEM AND DATA MANAGEMENT METHOD

(71) Applicant: OMIRON CORPORATION, Kyoto-shi, Kyoto (JP)

(72) Inventor: Fumihiro NAGASHIMA, Kyoto-shi, Kyoto (JP)

(73) Assignee: OMIRON CORPORATION, Kyoto-shi, Kyoto (JP)

(21) Appl. No.: 17/297,230

(22) PCT Filed: Dec. 6, 2019
(86) PCT No.: PCT/JP2019/047785

§ 371 Date: May 26, 2021

(30) Foreign Application Priority Data
Dec. 21, 2018 (JP) 2018-239644

(51) Int. Cl. G06F 21/62; G06F 21/31; G06F 21/44; G06F 21/45

(52) U.S. Cl. CPC G06F 21/62; G06F 21/31; G06F 2221/2141; G06F 21/45; G06F 21/44

(57) ABSTRACT

A data management system includes: a device capable of operating in accordance with each operational data among multiple operational data; a first setting means for setting a security policy for each operational data among the multiple operational data; a second setting means for setting security setting data for each operational data among the multiple operational data, the security setting data satisfying the security policy set to the operational data; an authentication means for performing authentication by matching input data with the security setting data set to target operational data; and a control means for causing the device to perform an operation in accordance with the target operational data, when the authentication is successful. This can reduce the time and labor required to set the security policy.

### TECHNICAL FIELD

The present technology relates to a data management system and a data management method.

### BACKGROUND ART

Japanese Patent Laying-Open No. 2002-203008 (PTL 1) discloses a custom product information providing device which selectively provides, in response to an inquiry request from a specific user, custom product information related to the order of the specific user.

### CITATION LIST

### Patent Literature

PTL 1: Japanese Patent Laying-Open No. 2002-203008

### SUMMARY OF INVENTION

### Technical Problem

A production system, which produces different types of products for multiple customers, includes a device that operates in accordance with operational data pre-designed for each product. The production system is configured to authenticate the operator so that the device is not operated by an unintended operator, and causes the device to operate in accordance with the operational data only if the authentication is successful. The administrator designs security management for the operational data, in accordance with security policies set to the operational data.

For a production system which produces different types of products for multiple customers, typically, the security policies are set so as to meet all the demands from the customers. Therefore, if a security management level demanded by a first customer is higher than a security management level demanded by a second customer, security policies at a level that is demanded by the first customer are set to the operational data corresponding to a product for the second customer too.

When the producer changes the primary components included in a manufacturing process, the producer is required to provide each customer with information related to the changes, as appropriate. Therefore, a need arises to inform the second customer, who demands for a relatively low security management level, of content of the change that has been made to the security policies responsive to the demand from the first customer for a change to the security management level. As a result, setting the security policies requires time and labor. With the technology disclosed in PTL 1, such time and labor cannot be reduced.

The present invention is made in view of the above problem, and an object of the present invention is to provide a data management system and a data management method which can reduce the time and labor required to set the security policies at a device capable of operating in accordance with each of the operational data.

### Solution to Problem

According to one example of the present disclosure, a data management system includes: a device operable in accordance with each operational data among multiple operational data; a first setting means; a second setting means; an authentication means; and a control means. The first setting means is configured to set a security policy for each operational data among the multiple operational data. The second setting means is configured to set security setting data for each operational data among the multiple operational data, the security setting data satisfying the security policy set to the operational data. The authentication means is configured to perform authentication by matching input data with the security setting data set to target operational data among the multiple operational data. The control means is configured to cause the device to perform an operation in accordance with the target operational data, when the authentication is successful.

According to the present disclosure, even if the security management level demanded by the first customer is higher than the security management level demanded by the second customer, the administrator is not required to adapt the security policies on the operational data for the second customer to the security policies on the operational data for the first customer. As a result, this obviates the need to inform the second customer of content of a change that has been made to the security policies, responsive to the demand from the first customer for a change to the security management level, and the time and labor required to set the security policies at the device can be reduced.

In the disclosure described above, the data management system further includes a server device for storing, for each operational data among the multiple operational data, the operational data, the security policy set to the operational data, and the security setting data set to the operational data, in association. The device includes an acquisition unit for receiving an instruction to select the target operational data from among the multiple operational data and obtaining from the server device the target operational data selected in response to the instruction.

According to the present disclosure, the device is not required to manage multiple operational data, allowing efficient utilization of the memory of the device.

In the disclosure described above, the first setting means is capable of updating the security policy for each operational data.

If the security policies on all the operational data are changed upon receipt of a demand for change to the security management level from the first customer, a need to inform the second customer that the security management level has been changed arises. However, according to the present disclosure, the administrator may only change the security policies on the operational data for the first customer. In other words, the security policies on the operational data for the second customer are not required to be changed. As a result, there is nothing to be informed of to the second customer, facilitating changes to the security policies.

In the disclosure described above, the security setting data includes association information set for each user, wherein the association information is information in which identification information identifying the user and a password assigned to the user are associated. According to the present disclosure, different passwords can be set for different users.

In the disclosure described above, the device is, for example, an image sensor which performs an image processing on an image which includes an image of an object and outputs a process result indicative of features of the object. In this case, the multiple operational data are data indicative of a method of the image processing. Alternatively, the device may be a control device for controlling a controlled device. In this case, the multiple operational data are data indicative of a method of control of the controlled device.

According to one example of the present disclosure, a data management method for managing multiple operational data which are used when a device operates, includes a first step, a second step, a third step, and a fourth step as follows. The first step is setting a security policy for each operational data among the multiple operational data. The second step is setting security setting data for each operational data among the multiple operational data, the security setting data satisfying the security policy set to the operational data. The third step is performing authentication by matching input data with the security setting data set to target operational data among the multiple operational data. The fourth step is causing the device to perform an operation in accordance with the target operational data, when the authentication is successful. This present disclosure can reduce the time and labor required to set the security policies at the device too.

### Advantageous Effects of Invention

According to the present invention, the time and labor can be reduced, which are required to set the security policies at a device capable of operating in accordance with each of the operational data.

### BRIEF DESCRIPTION OF DRAWINGS

FIG. 1 is a schematic diagram showing an overview of a data management system according to an embodiment of the present disclosure.

FIG. 2 is a block diagram showing one hardware configuration example of a device included in the data management system according to the embodiment.

FIG. 3 is a block diagram showing another hardware configuration example of the device included in the data management system according to the embodiment.

FIG. 4 is a schematic diagram showing a hardware configuration example of a server device included in the data management system according to the embodiment.

FIG. 5 is a schematic diagram showing a hardware configuration example of a management device included in the data management system according to the embodiment.

FIG. 6 is a block diagram showing functional configuration examples of the device and the management device included in the data management system according to the embodiment.

FIG. 7 is a diagram illustrating one example of a settings screen for setting security policies.

FIG. 8 is a diagram illustrating one example of a data structure for product A-related data.

FIG. 9 is a diagram illustrating one example of a popup window prompting for designation of target operational data.

FIG. 10 is a diagram illustrating one example of a popup window prompting for entry of a user ID and a password.

FIG. 11 is a flowchart showing one example flow of a security setting process performed by the management device.

FIG. 12 is a flowchart illustrating one example flow of an operational data utilizing process.

FIG. 13 is a block diagram showing functional configuration examples of a device and a management device which are included in a data management system according to Variation 1 of the embodiment.

### DESCRIPTION OF EMBODIMENTS

An embodiment according to the present invention will be described, with referenced to the accompanying drawings. Note that the same reference sign is used to refer to like or corresponding components in the drawings, and description thereof will not be repeated.

### § 1 Application

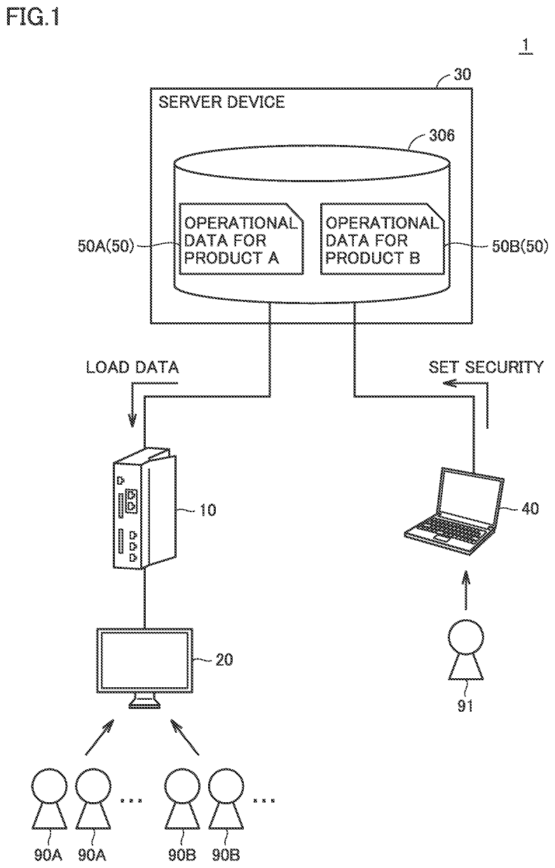

First, referring to FIG. 1, one example application of the present invention will be now described. FIG. 1 is a schematic diagram showing an overview of a data management system according to the present embodiment. A data management system 1 according to the present embodiment is applied to an industrial product production system.

As shown in FIG. 1, the data management system 1 includes a device 10, a console terminal 20, a server device 30, and a management device 40.

The device 10 is included in the production system, and performs operations on an object, such as raw materials, parts, semifinished products, and products, the operations including processing, assembling, conveying, and inspecting the object. The device 10 may directly operate the object, or indirectly operate the object via other devices. For example, the device 10 is a robot which assembles a product, an image sensor which inspects a product, a control device (typically, a programmable logic controller (PLC)) which controls a controlled device, etc. The image sensor performs an image processing on an image containing an image of the object, and outputs a result of the process indicative of features of the object. The process result includes dimensions of the object, a result of determination as to the quality of the appearance of the object.

The device 10 is capable of operations in accordance with respective multiple operational data 50. In the example shown in FIG. 1, the multiple operational data 50 include operational data 50A for producing a product A for a first customer, and operational data 50B for producing a product B for a second customer.

The console terminal 20 receives various operations to be performed on the device 10 from multiple users (hereinafter, referred to as “operators”) 90A, 90B. The operator 90A is responsible for the production of the product A. The operator 90B is responsible for the production of the product B. The console terminal 20 is configured of, for example, a widely-used computer or a human machine interface (HMI), and includes a display device and an input device.

The server device 30 manages multiple operational data 50 for causing the device 10 to operate. In the example shown in FIG. 1, the multiple operational data 50 (50A, 50B) are stored in a hard disk 306 of the server device 30. For example, if the device 10 is an image sensor, the multiple operational data 50 are data indicative of an image processing method. If the device 10 is a control device (e.g., PLC), the multiple operational data 50 are data indicative of a method of control of a controlled device.

In accordance with operations by an administrator 91, the management device 40 makes security settings for the multiple operational data 50 managed by the server device 30. Specifically, the management device 40 sets security policies for each operational data 50. Furthermore, the management device 40 sets security setting data satisfying the security policies set to the operational data 50.

The security setting data, typically, includes association information which is set for each of the operators 90A, 90B. The association information is information in which a user ID identifying the operators 90A, 90B and a password assigned to the operator are associated. The security policies, typically, define the number of characters that can be included in password, etc.

For the production of a product A, the operator 90A designates, as target operational data, the operational data 50A for causing the product A to operate, and enters the user ID and the password of the operator 90A to the console terminal 20. The password is pre-set to satisfy the security policies set to the operational data 50A. Similarly, for the production of a product B, the operator 90B designates, as target operational data, the operational data 50B for causing the product B to operate, and enters the user ID and the password of the operator 90B to the console terminal 20. The password is pre-set to satisfy the security policies set to the operational data 50B.

The data management system 1 matches the data (i.e., the user ID and the password) entered into the console terminal 20 with the security setting data set to the target operational data, thereby performing authentication. If the authentication is successful, the data management system 1 causes the device 10 to operate in accordance with the target operational data.

This allows, when the first customer and the second customer demand different security management levels, the administrator 91 to set different security policies to the operational data 50A and the operational data 50B, using the management device 40. Even if, for example, the first customer demands for a security management level higher than the security management level demanded by the second customer, the administrator 91 is not required to adapt the security policies on the operational data 50B to the security policies on the operational data 50A. As a result, this obviates the need to inform the second customer that the security policies higher than demanded are set, thereby reducing the time and labor required to set the security policies at the device 10.

### § 2 Specific Example

Next, a specific example of the data management system 1 according to the present embodiment will be now described.

### A. Hardware Configuration Example of Device

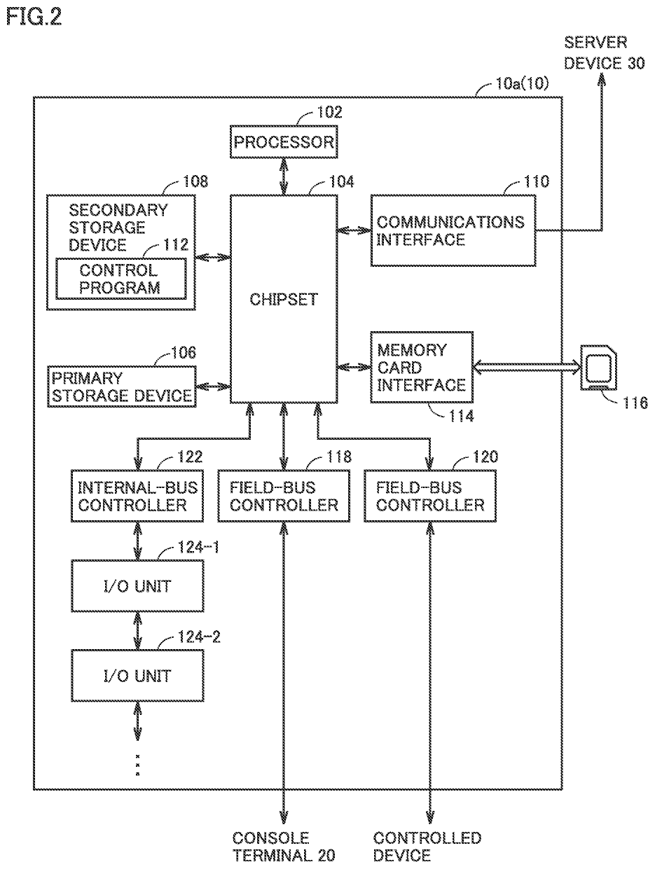

FIG. 2 is a block diagram showing one hardware configuration example of a device included in the data management system according to the present embodiment. FIG. 2 shows a hardware configuration of a device 10a operating as a PLC. Referring to FIG. 2, the device 10a includes a processor 102, such as a central processing unit (CPU) or a micro-processing unit (MPU), a chipset 104, a primary storage device 106, a secondary storage device 108, a communications interface 110, a memory card interface 114, an internal-bus controller 122, field-bus controllers 118, 120, and input/output (I/O) units 124-1, 124-2, and so on.

The processor 102 reads various programs, such as a control program 112, stored in the secondary storage device 108, and deploys and executes the programs on the primary storage device 106, thereby implementing controls that depends on a controlled device. The chipset 104 controls the processor 102 and respective components of the device 10a, thereby implementing the overall process of the device 10a.

The communications interface 110 controls exchange of data between the device 10a and other devices. The communications interface 110 is configured of, typically, an Ethernet (registered trademark) or a universal serial bus (USB), for example.

The memory card interface 114 is detachably connected to a memory card 116, and capable of writing data to the memory card 116, and reading various data from the memory card 116.

The internal-bus controller 122 is an interface which exchanges data with the I/O units 124-1, 124-2 mounted on the device 10a.

The field-bus controller 118 controls exchange of data between the device 10a and the console terminal 20. Similarly, the field-bus controller 120 controls exchange of data between the device 10a and a controlled device, via a field network.

Processes performed at the device 10a are implemented by the control program 112 executed by the processor 102. Such a control program 112 is pre-stored in the secondary storage device 108. Alternatively, the control program 112 may be commercially available as a program product stored in the memory card 116. Alternatively, the control program 112 may be provided as a program product that can be downloaded from, what is called, an information provider connected to the Internet.

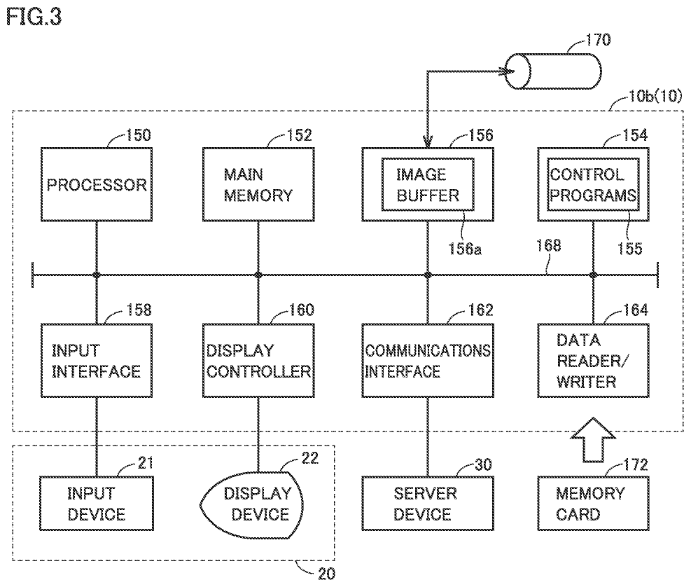

FIG. 3 is a block diagram showing another hardware configuration example of the device included in the data management system according to the present embodiment. FIG. 3 shows a hardware configuration of a device 10b operating as an image sensor. Referring to FIG. 3, the device 10b includes a processor 150, such as a CPU or a MPU, a main memory 152 and a hard disk 154 as storage units, a camera interface 156, an input interface 158, a display controller 160, a communications interface 162, and a data reader/writer 164. These components are connected to each other via a bus 168 so that data communications are allowed therebetween.

The processor 150 deploys control programs 155, stored in the hard disk 154, to the main memory 152, and executes then in a predetermined order, thereby performing various computations. The main memory 152 is, typically, a volatile storage device, such as a dynamic random access memory (DRAM). In addition to the programs read from the hard disk 154, the main memory 152 holds image data obtained by the camera 170, for example.

The camera interface 156 mediates data transmission between the processor 150 and the camera 170. In other words, the camera interface 156 is connected to a camera 170 for capturing an image of an object to generate image data. More specifically, the camera interface 156 includes an image buffer 156a for temporarily accumulating the image data from the camera 170. As a predetermined number of frames of image data are accumulated in the image buffer 156a, the camera interface 156 transfers the accumulated data to the main memory 152.

The input interface 158 mediates data transmission between the processor 150 and an input device 21 included in the console terminal 20. In other words, the input interface 158 receives operations to be performed on the input device 21 by the operators 90A, 90B.

The display controller 160 is connected to a display device 22 included in the console terminal 20. The display controller 160 notifies a user of a result of processing performed by the processor 150, for example. In other words, the display controller 160 controls a screen of the display device 22.

The communications interface 162 mediates data transmission between the processor 150 and the server device 30. The communications interface 162 is configured of, typically, an Ethernet (registered trademark) or a universal serial bus (USB), for example.

The data reader/writer 164 mediates data transmission between the processor 150 and a memory card 172 which is a recording medium. In other words, programs to be executed at the device 10b are commercially available, being stored the memory card 172, and the data reader/writer 164 reads the programs from the memory card 172. In response to internal commands from the processor 150, the data reader/writer 164 also writes to the memory card 172 the image data obtained by the camera 170 and/or the result of processing performed at the device 10b, for example. Note that the memory card 172 is configured of, for example, a widely-used semiconductor memory device, such as a secure digital (SD) memory storage device, a magnetic storage medium, such as a flexible disk, or an optical storage medium, such as a compact disk read only memory (CD-ROM).

FIGS. 2 and 3 show the configuration examples in which necessarily functions are provided by the processors 102, 150 executing the control programs 112, 155, respectively. However, some or all the functions provided may be implemented, using a dedicated hardware circuit (e.g., an application specific integrated circuit (ASIC) or a field-programmable gate array (FPGA), for example). Alternatively, the primary components of the device 10a, 10b may be implemented, using hardware that is in accordance with a widely-used architecture (e.g., an industrial personal computer based on a general purpose personal computer). In this case, a virtualization technique may be used to execute multiple operating systems (OS) for different applications purposes in parallel, and execute necessarily applications on each OS.

### B. Hardware Configuration Example of Server Device

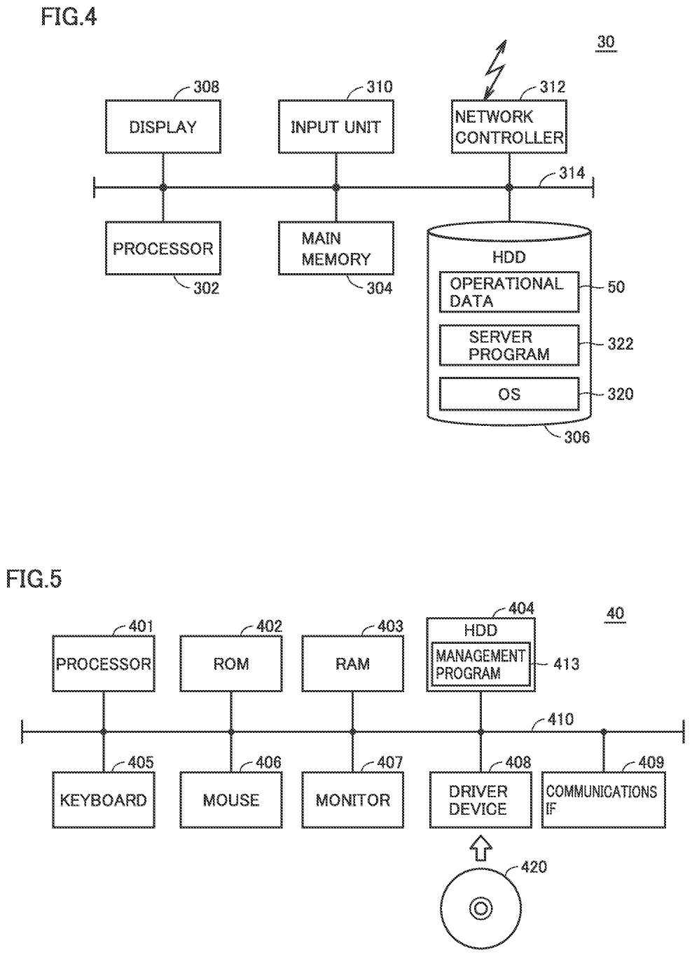

FIG. 4 is a schematic diagram showing a hardware configuration example of a server device included in the data management system according to the present embodiment. Referring to FIG. 4, the server device 30 is a computer having a widely-used architecture. The server device 30 implements various processes described below by the processor executing pre-installed programs.

The server device 30 includes a processor 302, such as a CPU or a MPU, a main memory 304, a hard disk (HDD) 306, a display 308, an input unit 310, such as a keyboard and a mouse, and a network controller 312 for exchanging data between the server device 30 and other devices. These components are connected to each other via an internal bus 314 so that data communications are allowed therebetween.

In addition to multiple operational data 50, the hard disk 306 holds an operating system (OS) 320 for providing basic program execution environment at the server device 30, and a server program 322 for implementing the data management system. These programs are read into the main memory 304 and executed by the processor 302.

### C. Hardware Configuration Example of Management Device

FIG. 5 is a schematic diagram showing a hardware configuration example of the management device included in the data management system according to the present embodiment. Referring to FIG. 5, as the primary components, the management device 40 includes: a processor 401 which executes programs; a ROM 402; a RAM 403 which stores, in a volatile manner, data generated by the execution of programs by the processor 401, or data input to the management device 40 via a keyboard 405 or a mouse 406; a HDD 404 which stores data in an non-volatile manner; the keyboard 405 and the mouse 406 which receive input; a monitor 407; a driver device 408; and a communications IF 409. These components are connected to each other by an interconnecting data bus 410. A recording medium 420, such as a DVD-ROM, is mounted on the driver device 408.

Processes performed at the management device 40 are implemented by a management program 413 that is executed by each hardware component and the processor 401. Such a management program 413 is pre-stored in the HDD 404. Alternatively, the management program 413 may be commercially available as a program product stored in a recording medium 420. Alternatively, the management program 413 may be provided as a program product that can be downloaded from, what is called, an information provider connected to the Internet.

### D. Functional Configuration Example of Data Management System

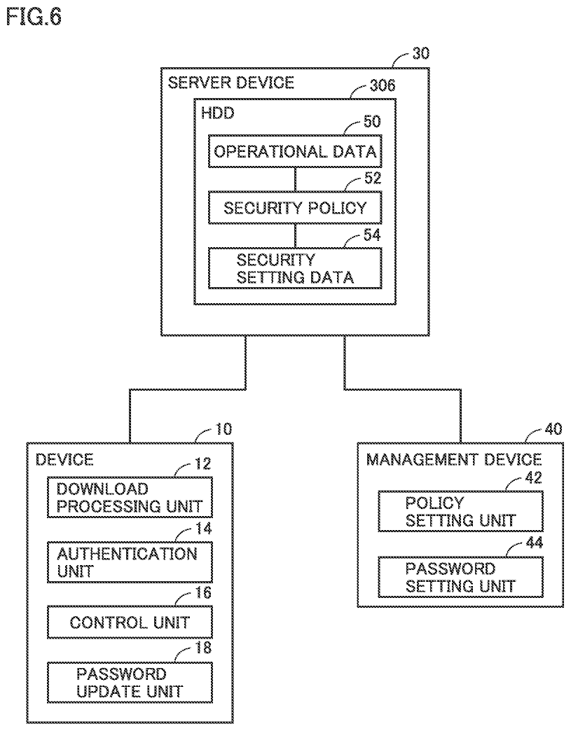

FIG. 6 is a block diagram showing functional configuration examples of the device and the management device which are included in the data management system according to the present embodiment. Referring to FIG. 6, the management device 40 includes a policy setting unit 42 and a password setting unit 44. The policy setting unit 42 and the password setting unit 44 are implemented by the processor 401 executing the management program 413 (see FIG. 5). The device 10 includes a download processing unit 12, an authentication unit 14, a control unit 16, and a password update unit 18. The download processing unit 12, the authentication unit 14, the control unit 16, and the password update unit 18 are implemented by the processor 102 executing the control program 112 (see FIG. 2). Alternatively, the download processing unit 12, the authentication unit 14, the control unit 16, and the password update unit 18 are implemented by the processor 150 executing the control program 155 (see FIG. 3).

Based on the input through the keyboard 405 and the mouse 406, the policy setting unit 42 sets security policies 52 to each of the multiple operational data 50.

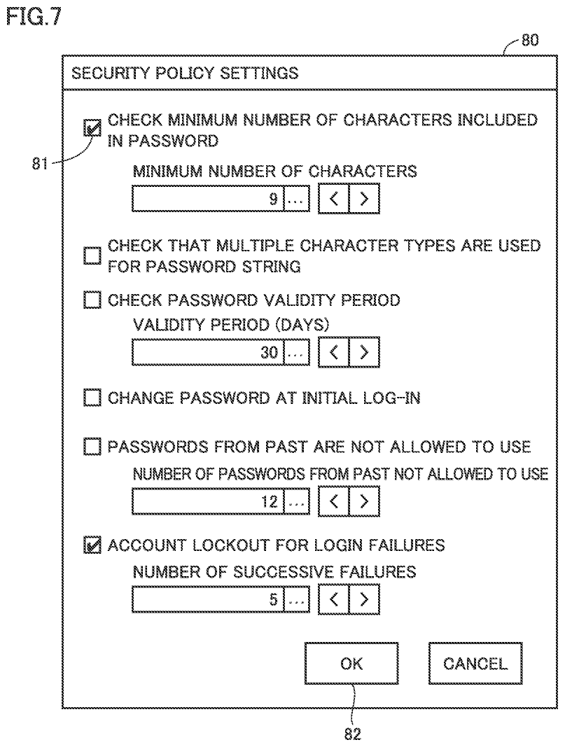

FIG. 7 is a diagram illustrating one example of a settings screen for setting the security policies. The policy setting unit 42 shows a settings screen 80 as shown in FIG. 7 on the monitor 407, thereby prompting for entry of security policies. The settings screen 80 is for setting six items as the security policies. The six items include the number of characters that can be included in password, character types used for password, a password validity period, whether to request to change the password at the initial log-in, the number of passwords from the past which are not allowed to use for password change, and the number of successive failures.

The settings screen 80 includes check boxes 81 for switching each item between enabled/disabled. As a check box 81 is checked, an item corresponding to the check box 81 is enabled.

As an OK button 82 is depressed on the settings screen 80, the policy setting unit 42 sets the security policies 52, in accordance with the entry into the respective items on the settings screen 80. Specifically, the policy setting unit 42 sets security policies 52 that show enabled/disabled with respect to the respective items, and indicate conditions set with respect to the enabled items.

Returning to FIG. 6, based on the entry through the keyboard 405 and the mouse 406, the password setting unit 44 sets security setting data 54 to each of the multiple operational data 50, the security setting data 54 satisfying the security policies set to the operational data 50. The security setting data 54 includes association information in which a user ID identifying an operator and an initial password assigned to the operator are associated. The operator is allowed to perform operations to cause the device 10 to operate in accordance with the operational data 50. Each association information further includes an update flag, update date information indicative of the latest date when the password is set, and passwords used in the past. The password setting unit 44 sets the update flag to “0.” The password setting unit 44 registers “Null” to passwords used in the past.

For each of the multiple operational data 50, the management device 40 registers, with the hard disk 306 included in the server device 30, the related data in which the operational data; the security policies 52 set by the policy setting unit 42; and the security setting data 54 set by the password setting unit 44 are associated.

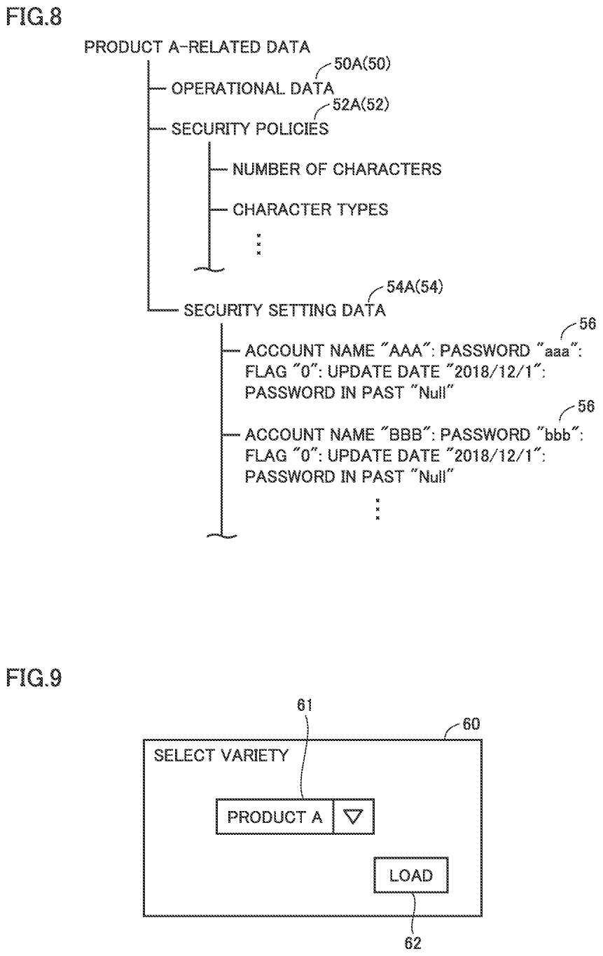

FIG. 8 is a diagram illustrating one example of a data structure of product A-related data. The product A-related data, having the data structure shown in FIG. 8, is stored in the hard disk 306 included in the server device 30. Referring to FIG. 8, the product A-related data is the data in which operational data 50A, security policies 52A set to the operational data 50A, and security setting data 54A satisfying the security policies 52A are associated. The security policies 52A includes the data indicative of conditions, such as the number of characters that can be included in password, character types used for password, etc. For each operator 90A, the security setting data 54A includes association information 56 in which an account name, as the user ID, and the password are associated.

Returning to FIG. 6, the download processing unit 12, included in the device 10, receives, via the console terminal 20, an instruction to select target operational data, and performs a process to obtain the target operational data from the server device 30. The download processing unit 12 shows a popup window prompting for designation of target operational data on the console terminal 20, and determines the target operational data in response to the entry into the popup window.

FIG. 9 is a diagram illustrating one example of the popup window prompting for designation of target operational data. A popup window 60 in the example shown in FIG. 9 includes a pull-down menu 61 for selecting target operational data, and a LOAD button 62 for instructing to start downloading of the target operational data. The operators 90A, 90B operate the pull-down menu 61 to select target operational data, and then press the LOAD button 62.

As the LOAD button 62 is depressed, the download processing unit 12 downloads from the server device 30 the selected target operational data, and the security policies 52 and the security setting data 54 set to the target operational data.

Returning to FIG. 6, the authentication unit 14 matches the data entered into the console terminal 20 with the security setting data 54 downloaded by the download processing unit 12, thereby performing authentication. The authentication unit 14 shows on the console terminal 20 a popup window prompting for entry of a user ID and a password, and performs authentication in response to the entry into the popup window.

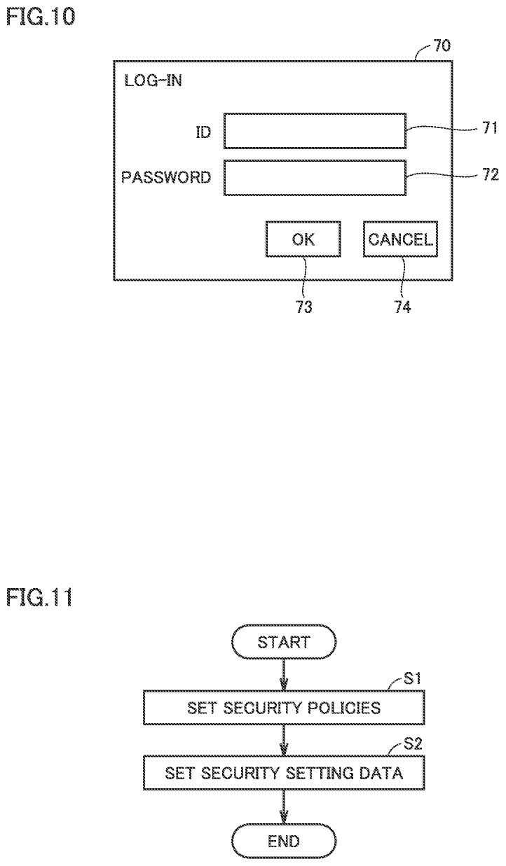

FIG. 10 is a diagram illustrating one example of a popup window prompting for entry of a user ID and a password. A popup window 70, in the example shown in FIG. 10, includes an entry field 71 for entering a user ID, an entry field 72 for entering a password, an OK button 73, and a Cancel button 74.

As the OK button 73 is depressed, the authentication unit 14 matches the user ID and the password entered into the entry fields 71, 72 with the security setting data 54 downloaded by the download processing unit 12, thereby performing authentication.

Note that if the security policies 52 downloaded by the download processing unit 12 define the number of successive failures, the authentication unit 14 compares the number of times the authentication is failed with the defined number of successive failures. If the number of times the authentication is failed reaches the defined number of successive failures, the authentication unit 14 performs a process, such as account lockout, for example.

If the authentication by the authentication unit 14 is successful, the control unit 16 controls the device 10 so that the device 10 operates in accordance with the target operational data downloaded by the download processing unit 12.

If the authentication by the authentication unit 14 is successful, the password update unit 18 determines whether the password is required to be updated. If determined that the password is required to be updated, the password update unit 18 performs a password update process.

The determination as to whether the password is required to be updated is carried out as follows. The password update unit 18 determines whether the security policies 52, downloaded by the download processing unit 12, indicate that the password at the initial log-in is “required” to be changed. If the security policies indicate that the password at the initial log-in is “required” to be changed, the password update unit 18 determines whether the update flag, included in the association information 56 corresponding to the entered user ID, indicates 0. If the update flag is “0,” the password update unit 18 determines that the password is “required” to be changed.

Furthermore, the password update unit 18 obtains a password validity period defined by the security policies 52. The password update unit 18 compares the days elapsed since the update date indicated by the update date information included in the association information 56 corresponding to the entered user ID, with the obtained password validity period. If the days elapsed exceeds the password validity period, the password update unit 18 determines that the password is “required” to be updated.

If determined that the password is “required” to changed, the password update unit 18 shows a popup window prompting for update of the password and entry of a new password on the console terminal 20. The password update unit 18 updates the password stored in the server device 30, in accordance with the entry in the popup window. At this time, the password update unit 18 changes the update date information corresponding to the password, and changes the update flag to “1.”

Furthermore, as a password used in the past, the password update unit 18 registers the password entered before the update, with the association information 56 corresponding to the entered user ID. If the number of passwords used in the past registered with the association information 56 exceeds the number of passwords from the past defined by the security policies 52, the password update unit 18 deletes the oldest password from the association information 56.

Note that the password update unit 18 determines whether the new password entered satisfies the security policies 52. If the new password entered fails to satisfy the security policies 52, the password update unit 18 shows a message prompting for re-entry of a password on the console terminal 20. At this time, preferably, the password update unit 18 shows, on the console terminal 20, the number of characters and the character types defined by the security policies 52. This facilitates the operators 90A, 90B to enter a password satisfying the security policies 52.

Furthermore, the password update unit 18 refers to the association information 56 to determine whether the new password entered matches a password used in the past. If the new password entered matches a password used in the past, the password update unit 18 shows a message prompting for re-entry of a password on the console terminal 20. At this time, preferably, the password update unit 18 shows a message prompting for entry of a password different from the password used in the past on the console terminal 20. This facilitates the operators 90A, 90B to enter a password different from the password used in the past.

### E. Flow of Security Setting Process

FIG. 11 is a flowchart illustrating one example flow of a security setting process performed by the management device. The management device 40 sets the security policies 52 to the operational data 50, based on input through the keyboard 405 and the mouse 406 (step S1).

Next, based on the input through the keyboard 405 and the mouse 406, the management device 40 sets the security setting data 54 satisfying the security policies 52 set to the operational data 50 (step S2). This ends the security setting process on the operational data 50.

The security setting process shown in FIG. 11 is performed upon creation of new operational data 50, and upon receipt of a demand for a change to the security management level from the customer. Upon creation of new operational data 50, the security setting process is performed on that operational data 50. Upon receipt of a demand for a change to the security management level from the customer, the security setting process is performed on operational data 50 that is used to produce a product for that customer. This allows the security policies 52 to be updated in response to the security management level demanded by the customer. For example, upon receipt of a demand for an increase in the security management level higher than the current level, the number of characters that can be used in password or the character types used for password is increased.

### F. Flow of Operational Data Utilizing Process

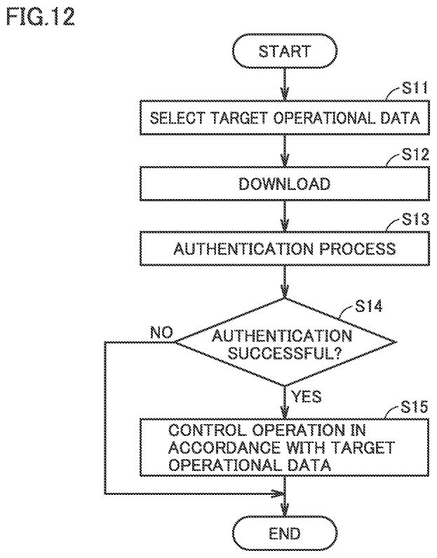

FIG. 12 is a flowchart illustrating one example flow of an operational data utilizing process. Based on the input to the console terminal 20, the device 10 selects target operational data from among the multiple operational data 50 (step S11). The device 10 downloads the target operational data, and the security policies 52 and the security setting data 54, set to the target operational data, from the server device 30 (step S12).

Next, the device 10 matches the input data to the console terminal 20 with the security setting data to perform authentication (step S13). If the authentication fails (NO in step S14), the operational data utilizing process ends. If the authentication is successful (YES in step S14), the device 10 is controlled so as to operate in accordance with the target operational data (step S15).

### G. Effects

As described above, the data management system 1 includes the policy setting unit 42, the password setting unit 44 and the password update unit 18, the authentication unit 14, and the control unit 16. The policy setting unit 42 sets the security policies 52 for each operational data 50. The password setting unit 44 and the password update unit 18 sets the security setting data 54 for each operational data 50, the security setting data satisfying the security policies 52 set to the operational data. The authentication unit 14 performs the authentication by matching input data with the security setting data 54 set to the target operational data. If the authentication is successful, the control unit 16 causes the device 10 to operate in accordance with the target operational data.

According to the present embodiment, even if the first customer demands a security management level higher than a security management level demanded by the second customer, the administrator 91 is not required to adapt the security policies on the operational data 50B to the security policies on the operational data 50A. As a result, this obviates the need to inform the second customer of content of the change made to the security policies, responsive to the demand from the first customer for a change to the security management level, and the time and labor required to set the security policies at the device 10 can be reduced.

The data management system 1 further includes the server device 30 which stores for each of the multiple operational data 50, operational data 50, the security policies 52 set to the operational data, and the security setting data 54 set to the operational data, in association. The device 10 includes the download processing unit 12, which is an acquisition unit for receiving an instruction to select target operational data from among the multiple operational data 50, and obtaining the target operational data from the server device 30.

This obviates the need for the device 10 to manage the multiple operational data 50, allowing efficient utilization of the memory of the device 10. Furthermore, the administrator 91 is allowed to readily set the security settings just by accessing the server device 30 separate from the device 10 that is installed in the production site.

The policy setting unit 42 is capable of updating the security policies 52 for each operational data 50.

If the security policies 52 on all the operational data 50 are changed upon receipt of a demand for change to the security management level from the first customer, a need arises to inform the second customer that the security management level has been changed. However, with the above configuration, the administrator 91 may only change the security policies 52 on the operational data 50A corresponding to a product A for the first customer. In other words, the administrator 91 is not required to change the security policies on the operational data 50B corresponding to a product B for the second customer. As a result, there is nothing to be informed of to the second customer, and changing the security policies is facilitated.

The security setting data 54 includes association information which is set for each operator. The association information is information in which identification information identifying the operator and a password assigned to the operator are associated. This allows different passwords to be set for different operators.

### H. Variation

### H-1. Variation 1

In the above description, the device 10 performs the authentication. However, the entity that performs the authentication is not limited to the device 10. For example, the server device 30 may perform the authentication.

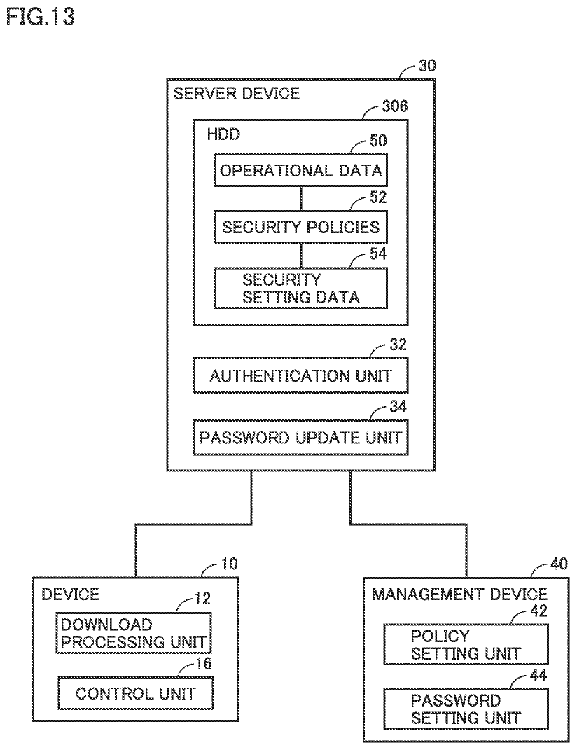

FIG. 13 is a block diagram showing functional configuration examples of a device and a management device which are included in a data management system according to Variation 1 of the present embodiment. Referring to FIG. 13, the device 10 according to Variation 1 is different in that the device 10 according to Variation 1 does not include the authentication unit 14 and the password update unit 18, as compared to the device 10 shown in FIG. 6. A server device 30 according to Variation 1 of the present embodiment is different in that the server device 30 further includes an authentication unit 32 and a password update unit 34, as compared to the server device 30 shown in FIG. 6.

The authentication unit 32 receives, from the device 10, data identification information identifying the target operational data selected, and the user ID and the password which are entered on the console terminal 20. The authentication unit 32 performs the authentication by matching the user ID and the password received from the device 10 with the security setting data 54 set to the target operational data indicated by the data identification information. If the authentication is successful, the authentication unit 32 outputs the target operational data to the device 10. This allows the control unit 16 to control the device 10 so that the device 10 operates in accordance with the target operational data.

As with the above password update unit 18, the password update unit 34 determines whether the password is required to be changed, based on security policies 52 set to the target operational data and the association information 56 that includes the user ID received from the device 10. If the password is required to be changed, the password update unit 34 instructs the device 10 to show a popup window prompting for update of the password and entry of a new password on the console terminal 20. The password update unit 34 receives from the device 10 a new password entered on the console terminal 20, and updates the security setting data 54 stored in the hard disk 306.

### H-2. Variation 2

In the above description, the server device 30 stores the operational data 50, the security policies 52, and the security setting data 54. However, the device 10 may store the operational data 50, the security policies 52, and the security setting data 54.

### H-3. Variation 3

In the above description, the management device 40 has the policy setting unit 42 and the password setting unit 44. However, the device 10 may have the policy setting unit 42 and the password setting unit 44.

### I. Appended Note

As described above, the present embodiment and the variation thereof include the disclosure as follows:

(Configuration 1)

A data management system (1), including:

a device (10, 10a, 10b) operable in accordance with each operational data among multiple operational data;

a first setting means (42, 401) for setting a security policy for each operational data among the multiple operational data;

a second setting means (44, 401, 18, 102, 150, 34, 302) for setting security setting data for each operational data among the multiple operational data, the security setting data satisfying the security policy set to the operational data;

an authentication means (14, 102, 150, 32, 302) for performing authentication by matching input data with the security setting data set to target operational data among the multiple operational data; and

a control means (16, 102, 150) for causing the device (10, 10a, 10b) to perform an operation in accordance with the target operational data, when the authentication is successful.

(Configuration 2)

The data management system (1) according to configuration 1, further including:

a server device (30) for storing, for each operational data among the multiple operational data, the operational data, the security policy set to the operational data, and the security setting data set to the operational data, in association, wherein

the device (10, 10a, 10b) includes an acquisition unit (12, 102, 150) for receiving an instruction to select the target operational data from among the multiple operational data and obtaining from the server device the target operational data selected in response to the instruction.

(Configuration 3)

The data management system (1) according to configuration 1 or 2, wherein

the first setting means (42, 401) is capable of updating the security policy for each operational data.

(Configuration 4)

The data management system (1) according to any one of configurations 1 to 3, wherein

the security setting data includes association information set for each user, wherein the association information is information in which identification information identifying the user and a password assigned to the user are associated.

(Configuration 5)

The data management system (1) according to any one of configurations 1 to 4, wherein

the device is an image sensor (10b) which performs an image processing on a captured image which includes an image of an object, and outputs a process result indicative of features of the object, and

the multiple operational data are data indicative of a method of the image processing.

(Configuration 6)

The data management system (1) according to any one of configurations 1 to 4, wherein

the device is a control device (10a) for controlling a controlled device, and

the multiple operational data are data indicative of a method of control of the controlled device.

(Configuration 7)

A data management method for managing multiple operational data which are used when a device (10, 10a, 10b) operates, the data management method including:

setting a security policy for each operational data among the multiple operational data;

setting security setting data for each operational data among the multiple operational data, the security setting data satisfying the security policy set to the operational data;

performing authentication by matching input data with the security setting data set to target operational data among the multiple operational data; and

causing the device (10, 10a, 10b) to perform an operation in accordance with the target operational data, when the authentication is successful.

While the embodiment according to the present invention has been described above, the presently disclosed embodiment should be considered in all aspects illustrative and not restrictive. The scope of the present invention is defined by the appended claims. All changes which come within the meaning and range of equivalency of the appended claims are to be embraced within their scope.

### REFERENCE SIGNS LIST

1 data management system; 10, 10a, 10b device; 12 download processing unit; 14, 32 authentication unit; 16 control unit; 18, 34 password update unit; 20 console terminal; 21 input device; 22 display device; 30 server device; 40 management device; 42 policy setting unit; 44 password setting unit; 50, 50A, 50B operational data; 52, 52A security policy; 54, 54A security setting data; 56 association information; 60, 70 popup window; 61 pull-down menu; 62 LOAD button; 71, 72 entry field; 73, 82 OK button; 74 Cancel button; 80 settings screen; 81 check box; 90A, 90B operator; 91 administrator; 102, 150, 302, 401 processor; 104 chipset; 106 primary storage device; 108 secondary storage device; 110, 162 communications interface; 112, 155 control program; 114 memory card interface; 116, 172 memory card; 118, 120 field-bus controller; 122 internal-bus controller; 124 I/O unit; 152, 304 main memory; 154, 306 hard disk; 156 camera interface; 156a image buffer; 158 input interface; 160 display controller; 164 data reader/writer; 168 bus; 170 camera; 308 display; 310 input unit; 312 network controller; 314 internal bus; 320 OS; 322 server program; 402 ROM; 403 RAM; 404 HDD; 405 keyboard; 406 mouse; 407 monitor; 408 driver device; 409 communications IF; 410 data bus; 413 management program; and 420 recording medium.

1. A data management system, comprising:
a device operable in accordance with each operational data among multiple operational data;
a first setting component configured to set a security policy for each operational data among the multiple operational data;
a second setting component configured to set security setting data for each operational data among the multiple operational data, the security setting data satisfying the security policy set to the operational data;
an authentication component configured to perform authentication by matching input data with the security setting data set to target operational data among the multiple operational data; and
a control component configured to cause the device to perform an operation in accordance with the target operational data, when the authentication is successful.

2. The data management system according to claim 1, further comprising:
a server device for storing, for each operational data among the multiple operational data, the operational data, the security policy set to the operational data, and the security setting data set to the operational data, in association, wherein
the device receives an instruction to select the target operational data from among the multiple operational data and obtains from the server device the target operational data selected in response to the instruction.

3. The data management system according to claim 1, wherein
the first setting component is capable of updating the security policy for each operational data.

4. The data management system according to claim 1, wherein
the security setting data includes association information set for each user, wherein the association information is information in which identification information identifying the user and a password assigned to the user are associated.

5. The data management system according to claim 1, wherein
the device is an image sensor which performs an image processing on a captured image which includes an image of an object, and outputs a process result indicative of features of the object, and
the multiple operational data are data indicative of a method of the image processing.

6. The data management system according to claim 1, wherein
the device is a control device for controlling a controlled device, and
the multiple operational data are data indicative of a method of control of the controlled device.

7. A data management method for managing multiple operational data which are used when a device operates, the data management method comprising:
setting a security policy for each operational data among the multiple operational data;
setting security setting data for each operational data among the multiple operational data, the security setting data satisfying the security policy set to the operational data;
performing authentication by matching input data with the security setting data set to target operational data among the multiple operational data; and
causing the device to perform an operation in accordance with the target operational data, when the authentication is successful.

8. The data management method according to claim 7, further comprising:
receiving, by the device, an instruction to select the target operational data from among the multiple operational data; and
obtaining, by the device, from a server device the target operational data selected in response to the instruction, the server device storing, for each operational data among the multiple operational data, the operational data, the security policy set to the operational data, and the security setting data set to the operational data, in association.

9. The data management method according to claim 7, wherein
setting the security policy includes updating the security policy for each operational data.

10. The data management method according to claim 7, wherein
the security setting data includes association information set for each user, wherein the association information is information in which identification information identifying the user and a password assigned to the user are associated.

11. The data management method according to claim 7, wherein
the device is an image sensor which performs an image processing on a captured image which includes an image of an object, and outputs a process result indicative of features of the object, and
the multiple operational data are data indicative of a method of the image processing.

12. The data management method according to claim 7, wherein
the device is a control device for controlling a controlled device, and
the multiple operational data are data indicative of a method of control of the controlled device.
